(19) United States
(12) Patent Application Publication
(10) Pub. No.: US 2022/0305931 A1
(43) Pub. Date: Sep. 29, 2022

(54) CHARGING FACILITY AND METHOD OF CONTROLLING CHARGING FACILITY

(71) Applicant: TOYOTA JIDOSHA KABUSHIKI KAISHA, Aichi-ken (JP)

(72) Inventor: Shigeki KINOMURA, Toyota-shi (JP)

(21) Appl. No.: 17/699,182

(22) Filed: Mar. 21, 2022

(30) Foreign Application Priority Data
Mar. 26, 2021 (JP) 2021-053171

(51) Int. Cl. B60L 53/31; B60L 53/30; B60L 53/60; H02J 7/00; B60L 53/16

(52) U.S. Cl. CPC B60L 53/31; B60L 53/305; B60L 53/60; H02J 7/0071; B60L 53/16

(57) ABSTRACT

A charging stand comprises: a movable part including a charging connector to transmit power to a vehicle; an elevating unit that moves up and down the movable part between an accommodated state in which the movable part is accommodated under the ground and an exposed state in which the movable part is exposed to the ground; and a controller that controls the elevating unit. The controller controls the elevating unit such that the movable part maintains the accommodated state for the first time zone and the movable part maintains the exposed state for a second time zone different from the first time zone.

This nonprovisional application is based on Japanese Patent Application No. 2021-053171 filed on Mar. 26, 2021 with the Japan Patent Office, the entire contents of which are hereby incorporated by reference.

### BACKGROUND

### Field

The present disclosure relates to a charging facility and a method of controlling the charging facility, and more particularly, to a control technique of the charging facility for charging a vehicle.

### Description of the Background Art

Vehicles capable of so-called plug-in charging by electric power supplied from the outside of the vehicle are becoming widespread. A charging facility for plug-in charging is generally installed in a parking lot or the like, but occupies a certain degree of installation space. Therefore, a technique has been proposed in which a charging facility is movable and accommodated under the ground. For example, a charging ball disclosed in Japanese Patent No. 5475407 is configured to be able to rise from the ground and to be able to be in a state of being accommodated under the ground.

### SUMMARY

The mobile charging facility may be installed on a walkway or the like proximate to the parking space. Since the movable part is accommodated under the ground when not in use, it is difficult for a pedestrian to recognize the presence of the movable part. Therefore, there is a possibility that the passage of a pedestrian is hindered when the movable part moves up and down.

The present disclosure has been made in order to solve the above-described problems, and an object of the present disclosure is to reduce the risk that the upward and downward movement of a movable part prevents the passage of a pedestrian in a movable charging facility.

(1) According to an aspect of the present disclosure, a charging facility comprises a movable part including a power transmitting unit that transmits power to a vehicle; an elevating device that moves the movable part up and down between an accommodated state in which the movable part is accommodated under the ground and an exposed state in which the movable part is exposed on the ground; and a control device that controls the elevating device. The control device controls the elevating device such that the movable part maintains the accommodated state for a first time zone and the movable part maintains the exposed state for a second time zone different from the first time zone.

In the configuration of (1), the accommodated state of the movable part is maintained for the first time zone, and the exposed state of the movable part is maintained for the second time zone. This prevents the movable part from being repeatedly raised and lowered for the first and second time zones. Therefore, according to the configuration of (1), it is possible to reduce the risk that the upward and downward movement of the movable part hinders the passage of a pedestrian.

(2) The control device controls the elevating device so that the movable part maintains the accommodated state for the first time zone regardless of a user operation.

In the configuration (2), for the first time zone during which the movable part is maintained in the accommodated state, the movable part is prohibited from rising irrespective of the user operation. This can further reduce the risk of the movable part moving up and down and preventing a pedestrian from passing through.

(3) The control device controls the elevating device so that the movable part is in the exposed state in response to a user operation even for the first time zone, and the control device controls the elevating device so that the movable part is in the accommodated state again after charging the vehicle using the charging facility ends. In the configuration (3), when the user operation is performed even for the first time zone during which the movable part is maintained in the accommodated state, the movable part is allowed to rise. Thus, the vehicle can be charged, and the convenience of the user can be improved. Further, once the charging is completed, the movable part returns to the accommodated state again, so that the aesthetic appearance can be improved.

(4) The first and second time zones are determined based on a condition of congestion around the charging facility.

In the configuration of (4) above, the first and second time zones are determined based on the number of pedestrians around the charging facility, and the risk of the movable part being moved up and down and preventing a pedestrian from passing can be more effectively reduced.

(5) According to another aspect of the present disclosure, there is provided a method for controlling a charging facility, the charging facility comprising: a movable part including a power transmitting unit that transmits power to a vehicle; and an elevating device that moves the movable part up and down between an accommodated state in which the movable part is accommodated under the ground and an exposed state in which the movable part is exposed on the ground. The method comprises: maintaining the movable part in the accommodated state for a first time zone; and maintaining the movable part in the exposed state for a second time zone different from the first time zone.

According to the method of (5) above, as well as the configuration of (1), it is possible to reduce the risk that the upward and downward movement of the movable part hinders the passage of pedestrians.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing an example of a layout of a charging system of a vehicle according to a first embodiment.

FIG. 2 is a diagram showing an example of a configuration of a charging station and a vehicle accommodated under the ground.

FIG. 3 is a diagram showing an example of a configuration of a charging station and a vehicle exposed on the ground.

FIG. 4 is a flow chart showing an example of a processing procedure of elevating control of a charging station according to the first embodiment.

FIG. 5 is a flowchart showing another example of the processing procedure of the elevating control of the charging station according to the first embodiment.

FIG. 6 is a flow chart showing an example of a processing procedure of elevating control of a charging station according to the second embodiment.

### DESCRIPTION OF THE PREFERRED EMBODIMENTS

Hereinafter, embodiments of the present disclosure will be described in detail with reference to the drawings. In the drawings, the same or corresponding portions are denoted by the same reference numerals, and the description thereof will not be repeated.

### Embodiment 1

### <Configuration of Charging System>

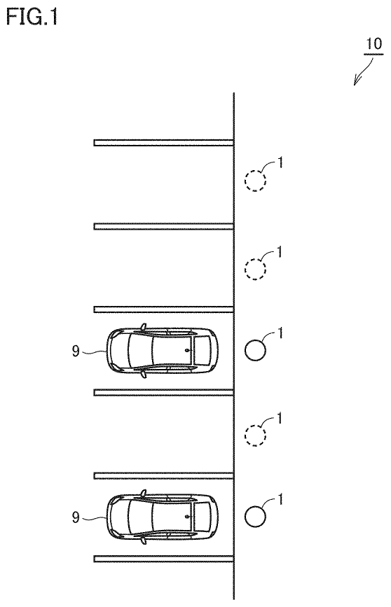

FIG. 1 is a diagram showing an example of a layout of a charging system according to a first embodiment. FIG. 1 shows how the vehicle 9 is parked in each of two of the plurality of parking spaces provided in the parking lot.

In the present embodiment, the charging system 10 includes a plurality of charging stands 1. Each of the plurality of charging stands 1 is installed in a space (e.g., a walkway) adjacent to the parking space. However, the number of the charging stands 1 is not particularly limited. Only one charging station 1 may be installed. The charging station 1 corresponds to a “charging facility” according to the present disclosure.

The charging system 10 is configured such that each charging station 1 can be raised and lowered (moved in the vertical direction) between an “accommodated state “accommodated under the ground and an “exposed state” exposed on the ground. In FIG. 1, a charging station 1 exposed on the ground is indicated by a solid line, and a charging station 1 accommodated under the ground is indicated by a broken line.

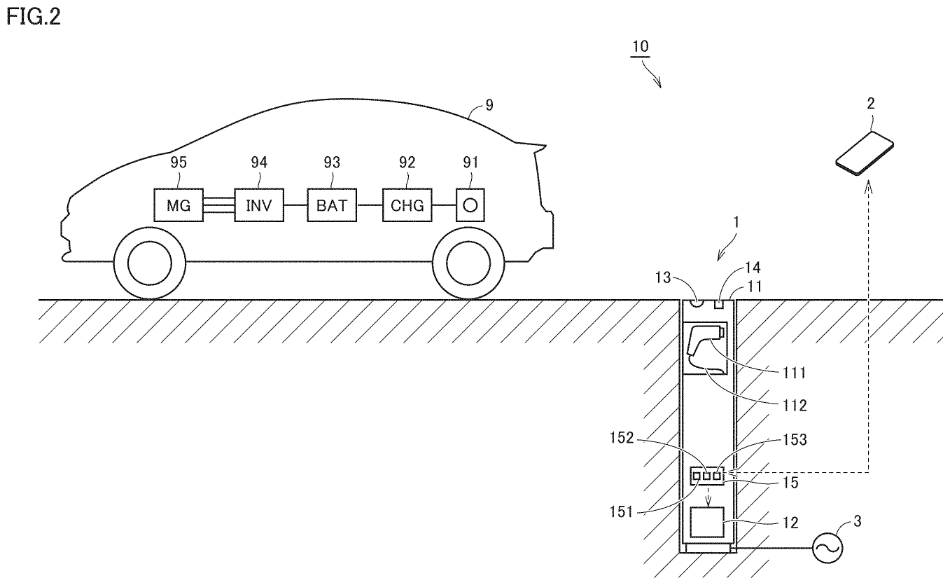

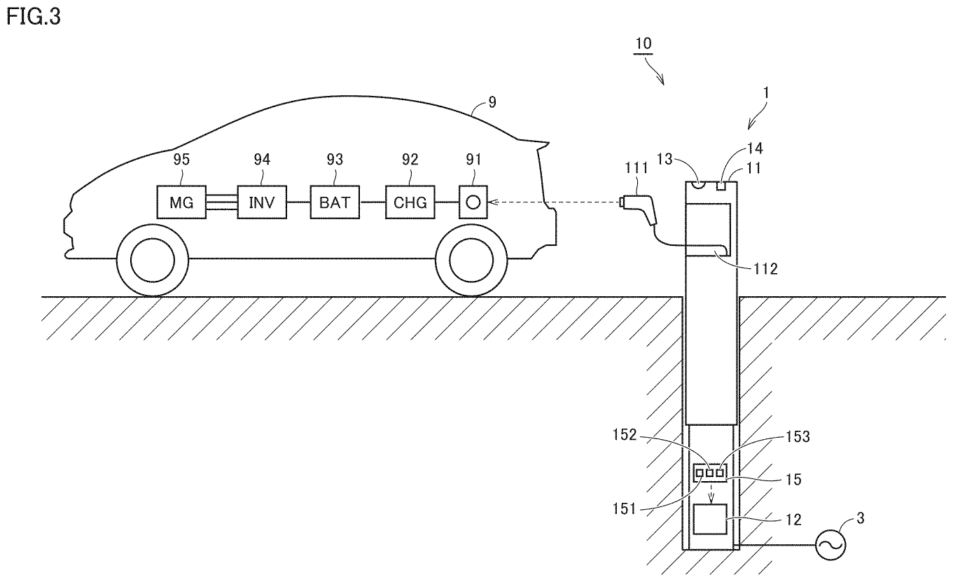

FIG. 2 is a diagram showing an example of the configuration of the charging station 1 and the vehicle 9 accommodated under the ground. FIG. 3 is a diagram showing an example of the configuration of the charging station 1 and the vehicle 9 exposed on the ground. As shown in FIG. 2, the accommodated state is a state in which the charging station 1 is lowered until the upper end of the charging station 1 becomes substantially the same height as the ground. As shown in FIG. 3, the exposed state is a state in which the upper end of the charging station 1 is raised to a predetermined height on the ground.

The charging station 1 has, for example, a cylindrical casing. The charging station 1 is installed on a bottom surface of a recess formed in the ground. The concave portion is formed so as to have a predetermined gap with the outer peripheral surface of the housing of the charging station 1. The depth of the concave portion is approximately equal to the vertical length of the charging stand 1 in the accommodated state.

The charging station 1 is configured to allow plug-in charging of the vehicle 9. The charging station 1 is configured to be capable of communicating with, for example, a mobile terminal (e.g., smartphone) 2 of a user. The charging station 1 is controlled in response to an operation performed by the user on the mobile terminal 2. The charging station 1 may be configured to be communicable with the vehicle 9. In this case, the charging station 1 is controlled in response to an operation performed on an operation panel or the like (not shown) of the vehicle 9. A dedicated operating device (not shown) may be provided separately from the charging station. The charging station 1 includes a movable unit 11, an elevating unit 12, and a controller 15.

The movable portion 11 is configured to be raised and lowered by the elevating unit 12. The up-and-down direction of the movable portion 11 is the vertical direction in this example, but may be inclined by a predetermined angle from the vertical direction. The movable portion 11 includes a charging connector 111 and a charging cable 112. The charging connector 111 and the charging cable 112 can be accommodated in an accommodation space provided in an upper portion of the movable portion 11.

The charging connector 111 is connected to an inlet 91 (described later) of the vehicle 9. The charging connector 111 is electrically connected to one end of the charging cable 112. A power supply 3 is electrically connected to the other end of the charging cable 112. The power supply 3 is, for example, an AC power supply such as a commercial power supply. A power converter (not shown) may be provided between the charging cable 112 and the power supply 3. The charging cable 112 can extend and contract to and from the inlet 91 when the user removes the charging connector 111 from the accommodation space. The charging connector 111 corresponds to the “power transmitting unit” according to the present disclosure.

The elevating unit 12 is fixed to a bottom surface of a recess formed in the ground. The elevating unit 12 raises and lowers the movable portion 11 between the accommodated state and the exposed state. Various mechanisms can be employed for the elevating unit 12. Specifically, the elevating unit 12 may have a rack-and-pinion mechanism, a mechanism using a hydraulic cylinder, or a magnetic mechanism. In the rack-and-pinion mechanism, the movable portion 11 is raised and lowered by rotating a pinion gear meshed with a rack gear fixed to the movable portion 11 using an electric actuator. In a mechanism using a hydraulic cylinder, a rod connected to a piston is fixed to the movable portion 11, and the movable portion 11 is raised or lowered by increasing or decreasing the hydraulic pressure supplied to the cylinder body. The magnetic force mechanism raises and lowers the movable portion 11 by generating a repulsive force due to a magnetic force between the movable portion 11 and the elevating unit 12.

The elevating unit 12 preferably includes a mechanism (such as a stopper) that restricts excessive movement of the movable portion 11 in the vertical direction. Thus, the elevating unit 12 is configured such that the movable portion 11 does not move downward beyond the position corresponding to the accommodated state, and such that the movable portion 11 does not move upward beyond the position corresponding to the exposed state. The elevating unit 12 corresponds to the “elevating/lowering device” according to the present disclosure.

The controller 15 includes a processor 151 such as a CPU (Central Processing Unit), a memory 132 such as a ROM (Read Only Memory) and a RAM (Random Access Memory), and a communication module 153 capable of performing wired and/or wireless communication with external devices of the charging station 1. In the present embodiment, the communication module 153 is configured to exchange various information with a communication module (not shown) of another charging station 1. Thus, a plurality of charging stations 1 can operate in cooperation with each other. The communication module 153 may be configured to be communicable with a management server (not shown) that can control a plurality of charging stations 1 in an integrated manner.

The controller 15 controls constituent devices (e.g., the elevating unit 12) of the charging station 1 based on information stored in the memory 132, information received via the communication module 153, and/or information acquired from sensors (not shown). The controller 15 executes a “up control” for raising the movable portion 11 and a “down control” for lowering the movable portion 11. The increase control is executed, for example, when the user operates the mobile terminal 2 to operate an up button (not shown). The downward control is executed when the user operates the down button (not shown) by operating the mobile terminal 2. The controller 15 corresponds to the “control device” according to the present disclosure.

The vehicle 9 is an electric vehicle in this example. The vehicle 9 may be any vehicle capable of plug-in charging, and may be, for example, a plug-in hybrid vehicle. The vehicle 9 includes an inlet 91, a charger 92, a battery 93, an inverter 94, and a motor generator 95.

The inlet 91 is disposed inside a cover (not shown) such as a lid provided in an exterior portion of the vehicle 9. The inlet 91 is configured to allow insertion of the charging connector 111 of the charging station 1. When the charging connector 111 is inserted into the inlet 91, the inlet 91 and the charging connector 111 are electrically connected to each other. This enables power transmission from the charging station 1 to the vehicle 9.

When AC power is supplied from the inlet 91, the charger 92 converts the AC power into DC power and supplies the DC power to the battery 93. The battery 93 is a secondary battery such as a nickel-hydrogen battery or a lithium-ion battery.

The inverter 94 converts the DC power stored in the battery 93 into AC power, and supplies the AC power to the motor generator 95. The inverter 94 converts AC power (regenerated power) from the motor generator 95 into DC power, and charges the battery 93 with the DC power. The motor generator 95 receives power from the inverter 94 and applies a rotational force to the driving wheels to cause the vehicle 9 to travel.

<Process Flow>

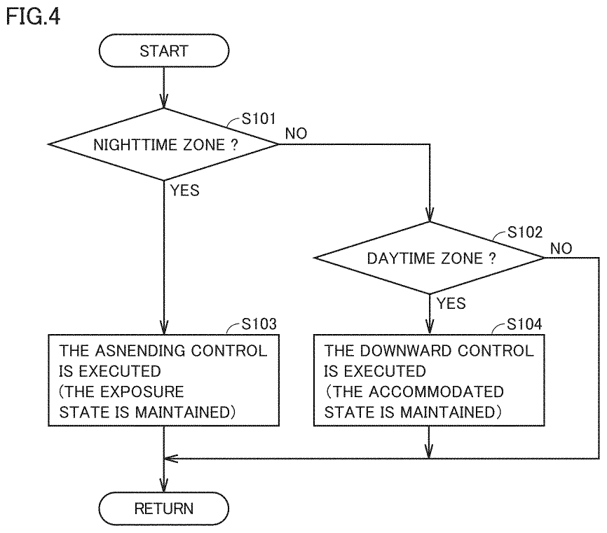

FIG. 4 is a flowchart showing an example of a processing procedure of elevating control of the charging station 1 according to the first embodiment. This flowchart is called from a main routine (not shown) and executed at predetermined intervals, for example. Each step is realized by software processing by the controller 15, but may be realized by hardware (electrical circuit) arranged in the controller 15. Each step may be executed by the management server (not shown) instead of the controller 15. Hereinafter, this step is abbreviated as S.

In FIG. 4, it is assumed that the charging station 1 is installed in a place where the opportunity for the vehicle 9 to be charged in the nighttime is higher than the opportunity for the vehicle 9 to be charged in the daytime (such as a residential place). In S101, the controller 15 determines whether or not the current time is the nighttime zone. When the current time is the nighttime zone (YES in S101), the controller 15 advances the process to S103 and controls the elevating unit 12 so as to execute the ascending control of the movable unit 11. The controller 15 controls the elevating unit 12 so that the movable portion 11 maintains the exposed state.

If the current time is not in the nighttime zone (NO in S101), the controller 15 determines whether the current time is in the current time or the daytime zone (S102). If it is the current time or daytime zone (YES in S102), the controller 15 advances the process to S104, and controls the elevating unit 12 to perform the downward control of the movable unit 11. The controller 15 controls the elevating unit 12 so that the movable portion 11 maintains the accommodated state.

When the current time is neither the nighttime zone nor the daytime zone (NO in S102), the controller 15 returns the process to the main routine. In this case, instead of the time zone, the movable portion 11 is moved up and down in accordance with an operation performed by the user on the mobile terminal 2 or the like.

As described above, in the example shown in FIG. 4, when the nighttime zone arrives, the movable portion 11 rises and is maintained in the exposed state. By maintaining the movable portion 11 in the exposed state in the nighttime zone where the charging opportunity is relatively high, it is possible to prevent the movable portion 11 from being raised and lowered repeatedly, and to allow the pedestrian to recognize the presence of the charging station 1. Therefore, it is possible to reduce the risk that the upward movement of the movable portion 11 hinders the passage of the pedestrian. On the other hand, when the daytime zone arrives, the movable portion 11 is lowered and maintained in the accommodated state. In the daytime zone in which the charging opportunity is relatively low, the movable portion 11 is maintained in the accommodated state so as not to be visible from the outside, whereby the aesthetic appearance can be improved.

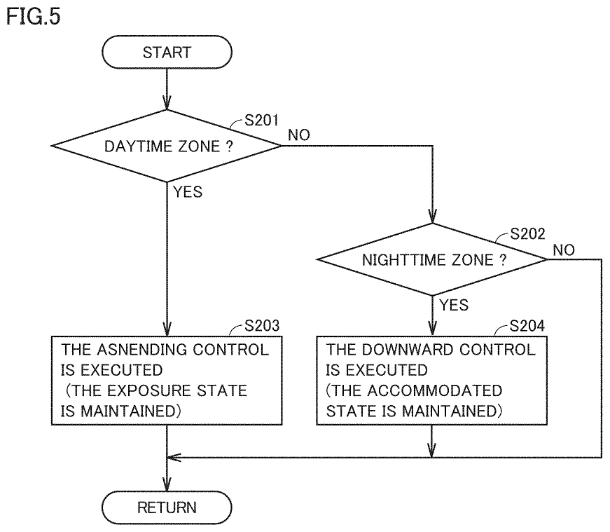

FIG. 5 is a flowchart showing another example of the processing procedure of the elevating control of the charging station 1 in the first embodiment. In this flowchart, contrary to the flowchart shown in FIG. 4, when the daytime zone arrives, the movable portion 11 rises and is maintained in the exposed state. On the other hand, when the nighttime zone arrives, the movable portion 11 is lowered and maintained in the accommodated state.

Thus, for example, in a place (such as a commercial place) where the opportunity used in the daytime zone is larger than the opportunity used in the nighttime zone, the time zones during which the exposed state and the accommodation state are maintained may be switched. This makes it possible to prevent the movable portion 11 from being moved up and down repeatedly in the daytime zone, and to allow the pedestrian to recognize the presence of the charging station 1 in the daytime zone. Therefore, it is possible to reduce the risk that the upward movement of the movable portion 11 in the daytime zone hinders the passage of the pedestrian. On the other hand, in the nighttime zone, the charging station 1 is maintained in the accommodated state so as not to be visible from the outside, whereby the aesthetic appearance can be improved.

As described above, in the first embodiment, when the predetermined time period (the second time period according to the present disclosure) arrives, the movable portion 11 rises to be in the exposed state, and is maintained in the exposed state thereafter. When another time zone (first time zone) arrives, the movable portion 11 is lowered to be in the accommodated state, and the accommodated state is maintained thereafter. The two time zones are determined in advance in consideration of the number of times of the charging opportunity of the vehicle 9 (the number of times the movable portion 11 can be moved up and down in accordance with the charging opportunity) and the congestion situation around the charging station 1 (e.g., increase or decrease of pedestrians per season). By maintaining the movable portion 11 in the exposed state, the number of times the movable portion 11 is raised and lowered can be reduced as compared with the case where the movable portion 11 is raised and lowered for each charging opportunity of the vehicle 9. In addition, the pedestrian can recognize the presence of the charging station 1. Therefore, it is possible to reduce the risk that the moving up and down of the movable portion 11 hinders the passage of the pedestrian.

In the example shown in FIGS. 4 and 5, the upward and downward movement of the movable portion 11 is controlled in accordance with the time zone. In these examples, the movable portion 11 is not raised or lowered in response to a user operation. Thus, even if the user performs an operation to raise the movable portion 11 in a time zone in which the number of peripheral pedestrians is large, such as the school time zone or the commutation time zone, the movable portion 11 is maintained in the accommodated state. In other words, the movement of the movable portion 11 by the user's operation is prohibited. Therefore, it is possible to further reduce the risk that the upward and downward movement of the movable portion 11 hinders the passage of the pedestrian.

Instead of previously setting the “first time zone” and the “second time zone” according to the present disclosure, the controller 15 may learn the magnitude of the charging opportunity of the vehicle 9 from the charging frequency during the past predetermined period. Further, the controller 15 may determine the congestion state around the charging station 1 by extracting, for example, a person in an image captured by a camera (not shown).

### Embodiment 2

In the second embodiment, a configuration will be described in which a user operation for lifting the movable portion 11 is accepted. The configuration of the charging system 10 according to the second embodiment is equivalent to the system configuration described in the first embodiment (see FIGS. 2 and 3).

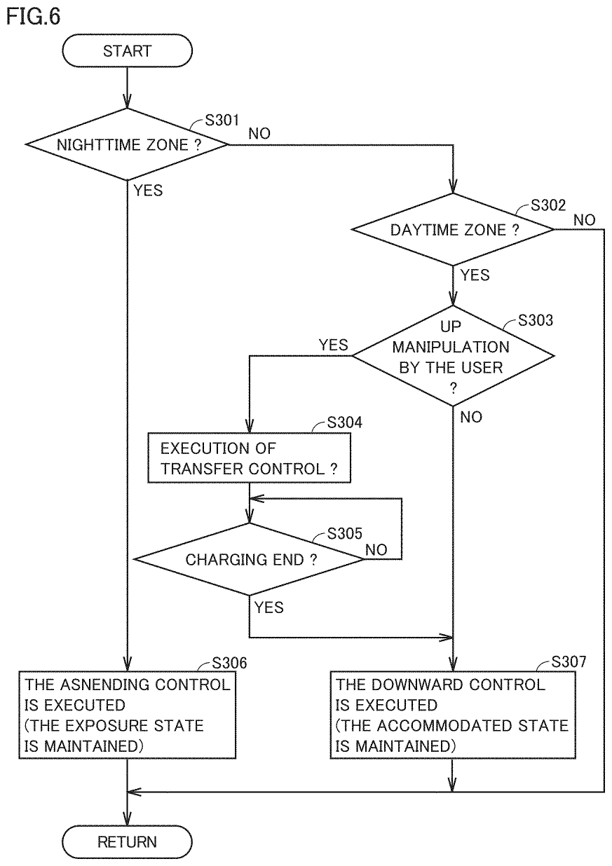

FIG. 6 is a flowchart showing an example of a processing procedure of elevating control of the charging station 1 according to the second embodiment. Since the processes of S301 and S306 are the same as the processes of S101 and S103 (see FIG. 4) in the first embodiment, the description thereof will not be repeated.

When the current time is the daytime zone (YES in S302), the controller 15 advances the process to S303 and determines whether or not a user operation (a lifting operation by the user) for lifting the movable portion 11 has been performed. When the upward operation by the user is not performed (NO in S303), the controller 15 controls the elevating unit 12 to perform downward control of the movable portion 11 as in the first embodiment. Then, the controller 15 controls the elevating unit 12 so that the movable portion 11 maintains the accommodated state (S307).

On the other hand, when the user performs a lifting operation (YES in S303), the controller 15 controls the elevating unit 12 to perform lifting control of the movable portion 11 (S304). The controller 15 controls the elevating unit 12 so that the movable portion 11 maintains the exposed state until the charging of the vehicle 9 is completed (NO in S305). When the charging of the vehicle 9 is completed (YES in S305), the controller 15 advances the process to S307, and controls the elevating unit 12 so as to execute the descending control of the movable portion 11. Thereafter, the accommodated state of the movable portion 11 is maintained.

As described above, in the second embodiment, when the user performs the upward operation even during the time period during which the movable portion 11 is maintained in the accommodated state, the upward control of the movable portion 11 is permitted. This makes it possible to charge the vehicle 9, thereby improving the convenience of the user. However, when the charging is completed, the movable portion 11 is placed in the accommodated state again. Although not shown, in the example shown in FIG. 6, the nighttime zone (S301) and the daytime zone (S302) may be interchanged.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A charging facility comprising:
a movable part including a power transmitting unit that transmits power to a vehicle;
an elevating device that moves the movable part up and down between an accommodated state in which the movable part is accommodated under the ground and an exposed state in which the movable part is exposed on the ground; and
a control device that controls the elevating device, wherein
the control device controls the elevating device such that the movable part maintains the accommodated state for a first time zone and the movable part maintains the exposed state for a second time zone different from the first time zone.

2. The charging facility according to claim 1, wherein the control device controls the elevating device so that the movable part maintains the accommodated state for the first time zone regardless of a user operation.

3. The charging facility according to claim 1, wherein the control device:
controls the elevating device so that the movable part is in the exposed state in response to a user operation even for the first time zone; and
controls the elevating device so that the movable part is in the accommodated state again after charging the vehicle through the charging facility ends.

4. The charging facility according to claim 1, wherein the first and second time zones are determined based on a condition of congestion around the charging facility.

5. A method for controlling a charging facility, the charging facility comprising:
a movable part including a power transmitting unit that transmits power to a vehicle; and
an elevating device that moves the movable part up and down between an accommodated state in which the movable part is accommodated under the ground and an exposed state in which the movable part is exposed on the ground, the method comprising:
maintaining the movable part in the accommodated state for a first time zone; and
maintaining the movable part in the exposed state for a second time zone different from the first time zone.
